(19) United States
(12) Patent Application Publication
(10) Pub. No.: US 2022/0302743 A1
(43) Pub. Date: Sep. 22, 2022

(54) QUICK LOADING UNIT

(71) Applicant: Charles Rippert, L'Amettla de Mar (ES)

(72) Inventor: Charles Rippert, L'Amettla de Mar (ES)

(21) Appl. No.: 17/639,089

(22) PCT Filed: Aug. 20, 2020
(86) PCT No.: PCT/EP2020/073284

§ 371 Date: Feb. 28, 2022

(30) Foreign Application Priority Data
Aug. 26, 2019 (CH) 01071/19

(51) Int. Cl. H02J 7/34; H02J 7/00

(52) U.S. Cl. CPC H02J 7/345; H02J 7/342; H02J 7/0024; H02J 7/0019; H02J 2207/50

(57) ABSTRACT

The charging unit comprises a number of stationary capacitors for charging mobile capacitors, which can be connected via a connecting socket. The charging unit comprises switching devices for connecting a first capacitor to the mobile capacitors and for the stepwise connection of a further capacitor in each case. The number and respective capacitance of the stationary capacitors is greater than that of the mobile capacitors. Between the individual steps, the stationary capacitors are separated from the mobile capacitors and the respective capacitors are connected in parallel, so that their voltage states can be equalized.

### CROSS REFERENCE TO RELATED APPLICATION

This application claims priority to international PCT application PCT/EP2020/073284 filed Aug. 7, 2020, which claims priority to a Switzerland application 01071/19 filed Aug. 26, 2019, both of which are hereby incorporated by reference in their entireties.

### FIELD OF INVENTION

The invention relates to a rapid charging unit for charging mobile capacitors according to the generic concept of claim 1.

### BACKGROUND

Swiss Patent Applications 702/18 and 1142/18, which have not yet been published, describe methods and devices for charging mobile capacitors at a charging station, in which the mobile capacitors at a charging station are connected several times in succession to stationary charged capacitors whose charge is in each case higher than that of the mobile capacitors. The present application expressly refers to these two applications in order not to repeat facts which are described in detail therein and which are not directly related to the present invention.

The following terms are used in the present description:

“Mobile capacitors” are those that are not permanently connected to a power grid or the like and therefore have to be charged regularly at charging stations.

Typically, these are capacitors which are used in electrically operated vehicles, tools or other applications. The mobile capacitors are also referred to as “capacitors to be charged”.

Charged capacitors provided in a charging station to which the mobile capacitors are temporarily connected for charging are referred to as “stationary or charging capacitors”.

The term “relay” also includes improper relays, such as B. Semiconductor relays or other current or voltage controlled switches, such as solenoids or IGBTs.

The term “capacitors” also encompasses all energy stores in which electrical energy is stored not chemically, but physically, i.e. in simplified terms, in an electrostatic field between two plates. The capacitors therefore also include so-called supercapacitors, ultracapacitors, lithium-ion supercapacitors, hybrid capacitors and the like, and possibly future energy-storing components based on the principle of a capacitor.

It is known that when an empty capacitor A is connected to an identical fully charged capacitor B, the charges equalize within seconds and two half-full charged capacitors result. If an empty capacitor A is connected to two fully charged series-connected capacitors B1 and B2, a fully charged capacitor A and two half-fully charged capacitors BI and B2 are obtained within seconds.

The sum of all the internal resistances of all the components, as well as the dimensioning and different charge states of the capacitors involved, determine the maximum possible current to be expected when capacitors B charged to a greater extent than A charge the former.

At present, resistors or inductors are used to limit the current in the above configuration, which is known to lead to losses. This is a disadvantage of the known methods for charging capacitors.

In comparison to capacitors connected in parallel, capacitors connected in series make it possible to transmit higher voltages and thus larger amounts of electrical energy. Capacitors to be charged should therefore be charged in series.

According to the prior art, assemblies of capacitors must have so-called active or passive “balancing”, which is necessary in order that all cells or capacitors of an assembly firstly have the same voltage and secondly no cell is charged via its maximum permissible, specified nominal voltage. Balancing is necessary since, typically, individual capacitors connected in series have different internal resistances and thus, during a charging process, at the end have different voltages which could lead to damage individually by exceeding the specified maximum voltage. This is a further disadvantage of the known methods for charging capacitors. Therefore, the capacitors to be charged should also be connected in parallel between the energy transmission phases, so that they have the same voltages.

In energy transmission, the physical properties of the respective affected components limit the speed at which, or the amount of energy per time, which can be transmitted.

If the throttling of the speed is not feasible with losses, energy must be transmitted in smaller units. If capacitors charge other capacitors, throttling has hitherto been associated with losses.

If capacitors charge other capacitors directly, the transmission rate is limited by the respectively greater internal resistance of the capacitors involved. In the case of ultracapacitors, a considerable amount of current is transmitted within a very short time. If electronic components, such as cables and switching elements, are connected between them in order to control the energy transmission, they increase the overall resistance of the circuit, composed of the internal resistance of the capacitors plus that of the switching elements, on the one hand, and on the other hand most electronic components are not designed for the high currents which occur, for which reason they are damaged and can fail rapidly over time. This is a further disadvantage of the known methods for charging capacitors.

Known ultracapacitors typically have a maximum voltage of 2.7 volts. It is to be expected that future developments will enable higher values. For most applications, however, higher voltages are generally necessary, which is why several to many series-connected ultracapacitors are used.

If it is desired to completely charge such network with capacitors of the same capacitance, then, as already mentioned at the outset, twice as many capacitors are required on the current-supplying side as are to be charged. It is not only alternatively possible, but is also advisable in the sense of the invention, to equip a charging capacitor assembly with a substantially higher total capacitance, because a fully charged capacitor with a substantially greater capacitance can be used for an empty capacitor with the same maximum voltage approximately fully less the amount of energy delivered to it, which is manifested in a reduced voltage of the larger capacitor. If you want to load promptly, a combination of these two variants is also possible.

### SUMMARY OF THE INVENTION

It is an object of the present invention to overcome the aforementioned disadvantages.

According to the invention, this is achieved by the characterizing features of claim 1.

### DESCRIPTION OF THE DRAWINGS

Preferred exemplary embodiments of the invention are described below with reference to the accompanying drawings. What is shown is:

FIG. 1 a circuit diagram of a charging unit.

FIG. 2 diagrams of the charging current.

### DETAILED DESCRIPTION

The solution approach is based on:
that the components used have maximum load capacities which must be adhered to in a targeted manner,
that the capacitors to be charged are connected in series, which enables higher voltages at which substantially more energy can be transmitted in the same time units at the same currents and corresponds to speed optimization on the part of the capacitors to be charged,
that the charging capacitors are combined stepwise and with increasing number in series to form a composite, which corresponds to speed optimization on the part of the charging capacitors,
that in each case a further charging capacitor is included in the composite as soon as the resulting composite will comply with the maximum load capacity of the components,
that, in comparison with the capacitor network to be charged, the charging capacitor network has a substantially greater total capacitance, a greater maximum voltage, and thus a certain over dimensioning,
and that the energy-supplying capacitors are connected to one another in parallel between the portioned, energy-emitting partial phases, which should ideally also be done with the capacitors to be charged.

The combination of the stationary capacitors has a substantially greater total capacitance than the combination of the mobile capacitors. The combination of the stationary capacitors can be operated with a smaller, equal or larger number of capacitors in comparison with the number of capacitors of the mobile combination. Ideally, however, it has a larger number, namely 50% to 100% more than the combination of the mobile capacitors. If this is not the case, the mobile capacitors must expediently be connected all the more in parallel for charging.

When dimensioning the stationary capacitors, the following must be taken into account:

The more capacitance they have in comparison with the mobile capacitors to be charged, the more successive charging of mobile capacitor assemblies is possible without intermediate recharging of the stationary capacitor assembly. With sufficient dimensioning, (1) cheap night currents “bunkering”, (2) peak-demand times (peak traffic) are better served or are only served in the first place, and (3) the power grids running today at 90% of the load capacity are less loaded by adjusting the time of loading of the stationary capacitors.

If, in the present device, the stationary capacitors do not have substantially more capacitance than the mobile capacitors, it may result, especially if the equalization of the voltages of the stationary capacitors by the omission of an intermediate step of the parallel connection for equalization, that certain stationary capacitors, those which are first taken for energy transmission, are discharged to such an extent and in further steps are first completely discharged and then change the polarity, i.e. are negatively charged, which has three effects: The latter no longer contribute to the charging process, since they can no longer emit energy, they are negatively charged and therefore belong to the capacitors to be charged, which makes the charging process more inefficient, and they can be damaged by the polarity change.

This is one reason why the capacitance of the stationary capacitors should be substantially greater than that of the mobile capacitors. If it is not possible to use capacitively substantially larger capacitors in the stationary capacitor combination, for example because the largest capacitors currently available on the market are already used as mobile capacitors, a stationary capacitor can in turn consist of a plurality of capacitors connected in parallel.

Between individual charging phases or charging pulses during the process of charging mobile capacitors by stationary capacitors, both should be connected in parallel for an instant, so that they “inter-association”. If this is not done on the side of the stationary capacitors, the balancing currents after the charging process are possibly that they exceed the specifications.

If it does not take place on the side of the mobile capacitors, last damage can be caused by exceeding the specified individual maximum rated voltage.

The circuit diagram shown in the figure shows a charging unit in the state in which no charging of mobile capacitors takes place. The charging unit comprises seven capacitors C1 to C7 and relays R1 to R7 associated therewith.

The relays are of the type Double Pole Double Throw “DPDT” 1 (“two contacts two states”), for example OMRON G5V-2 or Finders 40.52.

All relays R1-R7 are in the switching position in which the positive poles of the capacitors are connected to one another via a line L1 and their negative poles are connected to one another via a line L2. The capacitors are thus connected in parallel via the lines L1 and L2 and via the relays R1-R7.

The drive terminals of the relays are each connected to a power supply B via switches S1 to S7 and a line L3. The drive terminals of the relays are also connected to one another via diodes D1 to D6.

The capacitors to be charged are not shown in the figure. They are connected to the connection socket J1. The connecting socket J1 also serves to connect the charging unit to a current source for charging the capacitors C1-C7.

The capacitors C1-C7 are connected to one another in such a way that they can be arranged in the manner of a stack by actuating the switches S1 to S7, C1 being the lowermost capacitor of the stack and being the first to be connected to the connecting socket J1 for charging mobile capacitors.

A further relay R8 is arranged between the relay R1 and the connecting socket J1 and serves to connect the charging unit to the connecting socket J1 or to disconnect between them.

The diodes D1 to D6 have the following function: If one of the switches S1 to S7 is actuated, it must be ensured that, together with the corresponding relay, all the relays located “below” are also actuated, to be precise at the same time. Thus, if, for example, S3 is actuated, the diodes D2 and D1 ensure that not only relays R3 but also relays R2 and R1 are activated. This is essential, since otherwise the various capacitors would be damaged. In this illustrative example, if only R3 were activated, the following situation would be:
the negative poles of the capacitors C1, C2, C4 to C7 would be connected to one another,
the positive poles of the capacitors C1, C3, C4 to C7 would be connected,
the negative pole of capacitor C3 would be connected to the positive pole of capacitor C2, whereby
the voltage of C2 plus C3 would be applied to the capacitors C1, C4 to C7 and thus destroy the latter, assuming that the stationary capacitors should be charged to substantially more than only 50% in order to be able to carry out their function (meaningfully).

In other words, the diodes D1 to D6 intercept this problem. In addition, it must be taken into account that this problem is independent of the state of R8, but if, in addition, partially charged mobile capacitors are also connected simultaneously via an activated relay R8, the capacitors C2 and C3 can possibly also be damaged.

In order to ensure a safe behaviour of the system, the principle must be taken into account that first (and depending on the state of charge of the mobile capacitors) the switches S1 to S7 should be activated, and only afterwards the switch S8, which makes it possible to use less expensive relays for R1 to R7, provided that the relay R8 is correctly dimensioned, i.e. considerably more stable, than the former 7. By more stable dimensioning is meant that R1 to R7 must be able to conduct the same currents which R8 must be able to switch, which makes a considerable difference.

The following is not listed in this circuit diagram:
Voltage sensor, which measures the voltage at the network of mobile capacitors and passes this on to the control electronics, which interrupts the charging process, i.e. ends as soon as the maximum permissible value is reached, or optionally continues in parallel configuration of the stationary AND mobile capacitors (see excursus),
Circuit diagram of the mobile capacitors, which results, however, according to the patents mentioned at the beginning,
Circuit diagram of the electronics which charge the stationary capacitors, which can be of various forms and would not contribute in a targeted manner here.

The sequence of the step-by-step connection of the capacitors C1-C7 is described below.

The network of mobile capacitors is connected to the terminal JI.
First, the switch S1 is pressed; as a result, the capacitor 1 connected to the relay R8,
the switch S8 is then pressed; as a result, the capacitor 1 charges the mobile capacitors; the current which now flows decreases constantly and the applied voltage increases.
If the current falls below a certain value, the switch S1 is released, then the switch S8 is released and the mobile capacitors are switched over from serial to parallel.
After approximately one second, the switch S2 is pressed and the mobile capacitors are switched to serial.
The switch S8 is now pressed; the two series-connected capacitors 1 and 2 now charge the mobile capacitors.
If the current falls below a certain value, the switch S8 is released, then the switch S2 is released and the mobile capacitors are switched over from serial to parallel.
After about one second, the switch S3 is pressed and the mobile capacitors are switched to serial.
The switch S8 is now pressed; the series-connected capacitors 1, 2 and 3 now charge the mobile capacitors.
If the current falls below a certain value, the switch S8 is released, then the switch S3 is released and the mobile capacitors are switched over from serial to parallel.
After about one second, the switch S4 is pressed and the mobile capacitors are switched to serial.
The switch S8 is now pressed; the series-connected capacitors 1, 2, 3 and 4 now charge the mobile capacitors.
If the current falls below a certain value, the switch S8 is released, then the switch S4 is released and the mobile capacitors are switched over from serial to parallel.
After about one second, the switch S5 is pressed and the mobile capacitors are switched to serial.
The switch S8 is now pressed; the series-connected capacitors 1, 2, 3, 4 and 5 now charge the mobile capacitors.
If the current falls below a certain value, the switch S8 is released, then the switch S5 is released and the mobile capacitors are switched over from serial to parallel.
After one second, the switch S6 is pressed and the mobile capacitors are switched to serial.
The switch S8 is now pressed; the series-connected capacitors 1, 2, 3, 4, 5 and 6 now charge the mobile capacitors.
If the maximum permissible voltage at the mobile capacitors is reached, or if the current falls below a certain value, the switch S8 is released, then the switch S6 is released and the mobile capacitors are switched over from serial to parallel.
After one second, the switch S7 is pressed and the mobile capacitors are switched to serial.
The switch S8 is now pressed; the series-connected capacitors 1, 2, 3, 4, 5, 6 and 7 now charge the mobile capacitors.
When the voltage at the mobile capacitors reaches the maximum permissible voltage, the switch S8 is released, then the switch S7 is released and the mobile capacitors are switched from serial to parallel.
After about one second, the mobile capacitors are switched to serial.
The charging process is now completed and the mobile capacitors are disconnected from J1.

The expression “if the current falls below a certain value” requires an explanation:

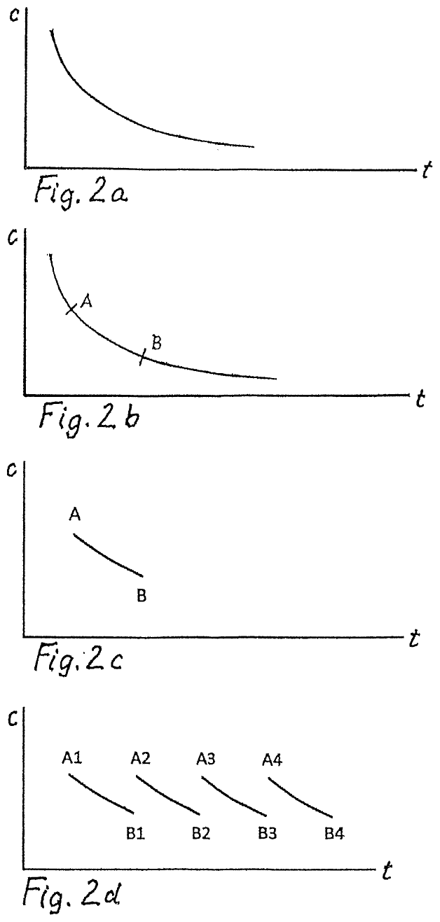

When a fully charged capacitor of identical type “charges” an empty capacitor, the current curve shown in the diagram of FIG. 2a is obtained. This process can be divided into three areas:
a. First, a very strong current flows, which can damage components (lines, control electronics, etc.). The invention described here is intended to prevent this, for which reason the charging process should not take place in this region.
b. During a certain time, a strong current flows.
c. From a certain point onwards, only a small amount of current flows, and one would have to wait a very long time for the charging process to be completely completed. Charging should not take place in this area.

Thus, it results that the charging process takes place in the region between the points A and B in the diagram shown in FIG. 2.

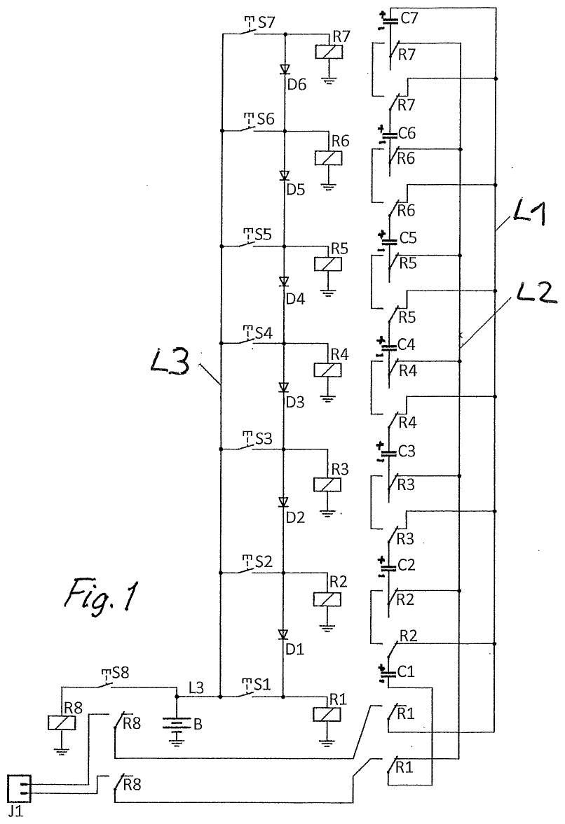

A single partial step is thus intended to cover the region shown in the diagram of FIG. 1c:

Several partial steps in succession cover the regions shown in the diagram of FIG. 2d:

During a partial charging step, that is to say when a switch S is pressed, current flows from the stationary capacitors to the mobile capacitors, which current decreases continuously. Thus, its tip lies at the beginning of a charging part step. So that it never exceeds a certain maximum value, in the above diagram, point A2 defines when B1 is reached. Thus, B1 represents the above-mentioned “certain value”. This can be calculated or determined experimentally.

Thus, the device always operates in the optimum range; maximum current intensities are never exceeded and the charging time is minimized.

The diodes D1 to D6 serve the purpose of simultaneously activating all required relays which switch the respective capacitor plus the “underlying” ones.

In the exemplary embodiment, the combination of mobile capacitors consists of five capacitors. However, it can also consist of a combination of a plurality of subassemblies of a multiple of capacitors which could be connected partially in parallel and partially in series for charging.

However, this has the disadvantage that the charging process lasts longer than when all mobile capacitors are connected in series, but in practice can have the advantage that, inter alia, a higher compatibility between mobile and stationary capacitors can be achieved or mobile capacitor interconnections which are designed for special applications (with high voltage requirements) can nevertheless be achieved by existing stationary capacitors.

Capacitor composites can still be loaded relatively quickly.

In general, it is advisable to first load a mobile capacitor assembly, such as a stationary capacitor assembly, connected in series, and to charge it in parallel in a second phase as soon as the voltage applied to the capacitors to be charged, which are still connected in series, approaches the maximum permissible nominal voltage.

Many solutions are available for charging the stationary capacitors, such as switched-mode power supplies or DC/DC converters (dc/dc-step up or -step down converters, aka buck converters). If a network of stationary capacitors consists of so many capacitors that, if they are connected in series, they have a maximum permissible total rated voltage of, for example, 240 volts, then a rectifier can also be used between the mains supply and stationary capacitors, in which case the access to the mains current must be able to supply at least as much current as the stationary capacitors are able to take up as much as possible, which is provided by the total internal resistance of all the components concerned, including the stationary capacitors. It should be noted that the voltage applied to the stationary capacitors increases constantly, while the flowing current decreases constantly.

Here, too, “logical three-pole relays” are suitable for better monitoring and optimal management, but do not necessarily have to be used.

If one imagines loading a truck equipped with capacitors, aka supercapacitors, in a short time, the required amount of energy is require the individual components to be selected and dimensioned accordingly, and that it is essential to load the supercapacitors of a truck step by step.

### Example

To test the function of the invention, a model prototype was realized. It consists of a stationary unit with stationary capacitors and a remote-controlled model car of the brand Carrera F150. The stationary unit contains seven SPSCAP brand supercapacitors with 3 kF each, the model car contains five SPSCAP brand supercapacitors with 150 F each. The mobile capacitors are soldered and connected in series. The stationary capacitors are connected analogously to the circuit diagram shown in the figure; for the sake of simplicity, only seven capacitors are shown in the circuit diagram. The manufacturer Carrera also supplies a rechargeable nickel metal hydride battery and recommends charging the battery for 90 minutes in order to be able to drive for 20 minutes.

The electronics of the model car were not altered in any way, except that those of the mobile capacitors were additionally soldered to the two feeding contacts, which originally came from the Ni-MH battery, and a switch was attached between them. This means that the model car can also be used in the original configuration. Test series confirm the manufacturer's information regarding charging time (90 minutes) and driving time (20 minutes).

So that the electronics of the model car can work according to the specifications of the manufacturer, first uses a step-up DC/DC converter between the mobile capacitors and the electronics of the model car, which increases the voltage to 20 volts. Thereafter, a step-down DC/DC converter was used which supplies 6 volts. A switch has been installed between the DC/DC converters and the electronics of the model car. The test series showed that the model car driven by the capacitors runs for 5 minutes with a charging time of 20 seconds. This efficiency was achieved without any particular optimization of the capacitive supply. The ratio of charging time to service life for capacitor operation is thus already more than 65 better than for battery operation. With appropriate optimization, the comparison factor could easily be doubled with supercapacitors currently available on the market.

Current research results show that the capacitance of capacitors can be increased from currently 0.3 F/cm2 to 4 F/cm2 and in THE near future to 11 F/cm2″ (source Superdielectrics Ltd.). For the remote-controlled model car, this would mean that with 2 minutes of charging, approximately 6.6 hours, or approximately 18 hours, could be driven. Thus, the comparison factor would be at least a further 3 to 7 times higher.

1. Charging unit having a number of stationary capacitors for charging mobile capacitors which can be connected via a connecting socket, characterized by switching devices for connecting a first capacitor to the mobile capacitors and for connecting in each case a further capacitor in steps, the number and respective capacitance of the stationary capacitors being greater than that of the mobile capacitors.

2. Charging unit according to claim 1, characterised by a relay between the stationary capacitor assembly and the connecting socket.

3. Method for charging mobile capacitors by means of a charging unit according to claim 1, characterized in that in each case stepped-in stationary capacitors are connected in, and between the individual steps the stationary capacitors are disconnected from the mobile capacitors, and the respective capacitors are connected in parallel, in order that their voltage states can be equalized.
